(19) United States
(12) Patent Application Publication
(10) Pub. No.: US 2026/0079783 A1
(43) Pub. Date: Mar. 19, 2026

(54) INTEGRATED MONITORING AND OBSERVABILITY OF ARTIFICIAL INTELLIGENCE SYSTEMS

(71) Applicant: Salesforce, Inc., San Francisco, CA (US)

(72) Inventors: Manjeet SINGH, San Francisco, CA (US); Jonathon Neal MOORE, Westfield, IN (US); Nabil NAFFAR, Tel Aviv (IL); Rami MANKEVICH, Tel Aviv (IL); Deepak MUKUNTHU, Bellevue, WA (US); Armen KHACHATRYAN, San Francisco, CA (US)

(73) Assignee: Salesforce, Inc., San Francisco, CA (US)

(21) Appl. No.: 19/030,532

(22) Filed: Jan. 17, 2025

Related U.S. Application Data
(60) Provisional application No. 63/695,254, filed on Sep. 16, 2024.

(51) Int. Cl. G06F 11/07

(52) U.S. Cl. CPC G06F 11/079; G06F 11/0709

(57) ABSTRACT

Disclosed herein are systems and methods for monitoring and observability of an artificial intelligence system. A method for monitoring and observability may include collecting monitoring data and metadata during setup and runtime of an artificial intelligence system. The method may also include performing a root cause analysis to determine a reason for performance issues of the artificial intelligence system using the monitoring data and the metadata. The monitoring data may include metrics, events, logs, and/or traces.

### CROSS REFERENCE TO RELATED APPLICATIONS

The present application claims benefit to U.S. Provisional Application No. 63/695,254 filed on Sep. 16, 2024 entitled “Integrated Monitoring and Observability of Artificial Intelligence Systems”, which is herein incorporated by reference in its entirety.

### BACKGROUND

Large Language Models (LLMs) are artificial intelligence (AI) models that can comprehend and generate human language text and other generative outputs based on a large data training set. LLMs are becoming integrated into a wide variety of fields, such as research, agent response, healthcare, translation, content creation, and a wide array of business applications.

LLM applications use increasingly complex abstractions, such as pipelines, agents with tools, and advanced prompts. Such applications are prone to errors or unintended model behaviors. Monitoring and observability of LLMs may allow a user to quickly identify and correct these errors.

### BRIEF DESCRIPTION OF THE DRAWINGS

The accompanying drawings are incorporated herein and form a part of the specification.

FIG. 1 shows an example environment, according to some embodiments.

FIG. 2 shows an example system, according to some embodiments.

FIG. 3 shows example monitoring and observability architecture, according to some embodiments.

FIG. 4 shows an example method for monitoring an artificial intelligence model, according to some embodiments.

FIG. 5 shows an example method, according to some embodiments.

FIG. 6 shows an example computer system, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program aspects, and/or combinations and sub-combinations thereof, for monitoring and observability of an artificial intelligence system. For example, a method for monitoring and observability may include collecting monitoring data and metadata during setup and runtime of an artificial intelligence system. The method may also include performing a root cause analysis to determine a reason for performance issues of the artificial intelligence system using the monitoring data and the metadata. The monitoring data may include metrics, events, logs, and/or traces.

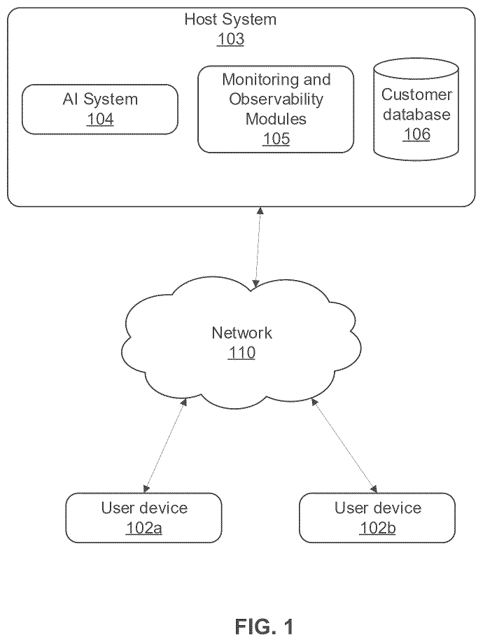

FIG. 1 shows a block diagram of an environment 100 in which example systems and/or methods may be implemented, in accordance with some embodiments. Environment 100 may include user devices 102a and 102b, which may take the form of a mobile device, a personal computer, or other electronics capable of communicating over a network, such as a smartphone, tablet, computer, personal digital assistant, smart watch, or the like. The environment may also include a host system 103. In some aspects, host system 103 may include all interfaces and functionality in support of a subscriber, as well as internal systems. Included within host system 103 is an artificial intelligence (AI) system 104 and monitoring and observability modules 105.

As shown in FIG. 1, user devices 102a and 102b may connect to the host system 103, AI system 104, and monitoring and observability modules 105 over a network 110. In some aspects, network 110 may comprise any type of computer or telecommunications network capable of communicating data, including but not limited to a local area network, a wide-area network (e.g., the Internet), or any combination thereof. The network may include wired and/or wireless segments. In some aspects, network 110 may be a secure network. In some aspects, one or more of user devices 102a and 102b may reside within network 110.

Host system 104 may have access to a plurality of databases or libraries, including a customer database 106. The customer database may include data relating to a specific company accessing a service, its employees, or business accounts associated with the company or its employees, such as one or more sales accounts. The customer database may be located within the host system, separate from the host system but still local, or accessible by the host system via network 110.

During operation, a user of user device 102a or 102b may access AI system 104 and monitoring and observability modules 105 and via network 110. The user may use AI system 104 to preform business related tasks. The user may configure monitoring and observability modules 105 to collect monitoring data related to the execution of AI system 104. The monitoring data may be used to determine and fix performance issues of AI system 104, as described in detail below.

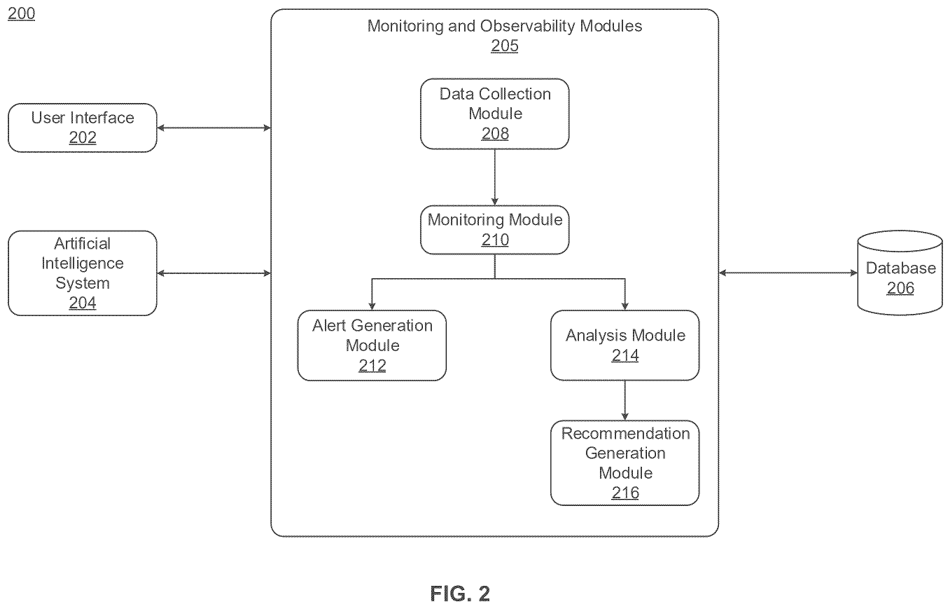

FIG. 2 shows a block diagram of an example system 200, in accordance with some embodiments. System 200 may contain both an artificial intelligence (AI) system and monitoring and observability modules in an integrated platform. An integrated platform may contain software that allows a user to develop and govern integration flows that connect diverse applications, systems, and databases. Connecting an AI system with monitoring and observability modules in an integrated platform streamlines monitoring by allowing data to stay within the platform. This may make it easier for a user to integrate metadata into observability workflows.

System 200 may include a user interface 202, an artificial intelligence (AI) system 204, and monitoring and observability modules 205 and a database 206. Monitoring and observability modules 205 may include a data collection model 208, a monitoring module 210, an alert generation module 212, an analysis module 214, and a recommendation generation module 216.

A user may access system 200 through user interface 202. User interface 202 may encompass buttons, text, images, sliders, text entry fields, and other similar components. In some embodiments, user interface 202 contains a dashboard that allows a user to configure monitoring and observability of AI system 204. For example, the dashboard may include a series of sliders or the like that allow a user to select which metrics to monitor and a monitoring sampling frequency.

In some embodiments, user interface 202 may include an interactive dashboard that allows a user to review collected monitoring data. For example, the interactive dashboard may allow the user to click on tabs to view successive granularities of monitoring data (e.g., metrics, logs, events, and traces).

In some embodiments, user interface 202 may contain a dashboard with data aggregation and filtering options. This may allow a user to visualize and slice collected data based on time (e.g., daily, weekly, monthly, date range), model name and version, prompt and version, user or groups, organization name, session ID, the type of generative AI feature (e.g., service replies, summarization), request channel source (e.g., chat, email, mobile), metric based filtering, and the like.

AI system 204 may contain one or more AI models. In some embodiments, the AI models are configured to assist a user with business related tasks. For example, the AI models may interpret and summarize business data, draft custom emails, automatically respond to customers via a chatbot, identify sales opportunities, and the like.

In some embodiments, AI system 204 contains one or more large language models (LLM). A LLM may be trained to summarize and generate content in response to a prompt generated by a user. In some embodiments, the user may generate the prompt using a prompt engine, which may contain a template-based framework that aids the user in creating an effective prompt. Additionally, an LLM may use retrieval augmented generation (RAG) to access knowledge outside of its training data source. For example, an LLM may use RAG to access customer specific data located in a company database (e.g., database 112).

In some embodiments, AI system 204 contains a trust layer. The trust layer may contain a set of features and guardrails that protect the privacy and security of a customer's data. For example, the trust layer may mask sensitive data (e.g., personal identifiable information) before a prompt is sent to a LLM and detect toxic language in a LLM response before the response is sent to a user.

In some embodiments, AI system 204 may contain a chatbot. The chatbot may use a LLM fine-tuned on domain specific data to engage in natural and fluid conversation with users.

A set of monitoring and observability modules 205 may collect and analyze monitoring data from AI system 204.

Data collection module 208 may be configured to collect data during runtime of AI system 204. For example, data collection module 208 may collect data associated with AI system requests, responses, and pipeline activities. The data may include metric values, events, logs, traces, inferences, and metadata. Traces may represent a single request or operation. For example, a trace can contain the overall input and output of a function, as well as metadata about the request, such as the user, the session, and tags. Each trace can contain multiple observations that log individual steps of an execution. For example, observations can include events, which may be used to track discrete events in a trace, spans, which represent durations of units of work in a trace, and generations, which are spans used to log generations of AI models. Generations can include additional attributes about a model, a prompt, and a completion.

In some embodiments, additional metadata may be complied that allows monitoring data to be easily searched, indexed, or analyzed. For example, the metadata may include vector resources, guardrail labeling, sentiment analysis, or additional model parameters generated outside of an AI model.

Monitoring module 210 may be configured to monitor key metrics related to the performance of AI system 204. For example, monitoring module 210 may sample monitoring data collected by data collection module 208 at a sampling frequency specified by a user. Monitoring module 210 may calculate values for metrics of interest using the sampled monitoring data. The sampled monitoring data and calculated metrics may be stored in database 206 as data lake objects and/or data model objects.

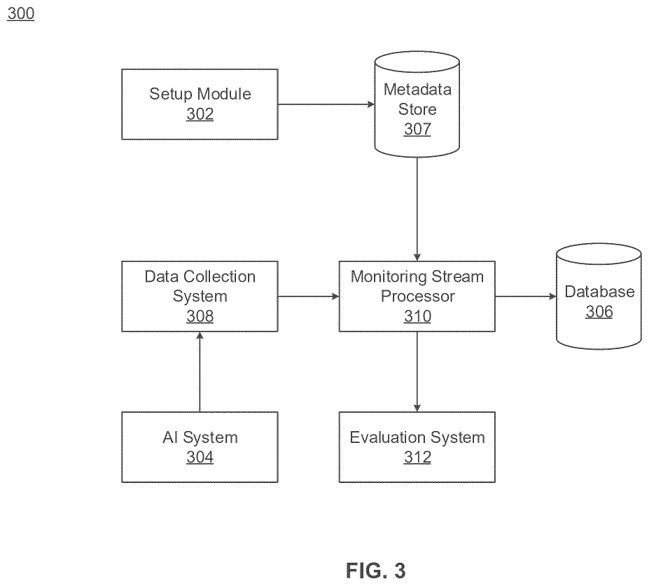

An alert generation module 212 may be configured to detect and send an alert to a user if a metric deviates from a predefined threshold. The threshold may be defined by a user during monitoring setup, as described in FIG. 3 below. Alert generation module 212 may send the alert to the user via user interface 202, via email, or the like.

An analysis module 214 may be configured to analyze historical and real-time monitoring data to identify a root cause of AI system performance issues. Analysis module 214 may analyze multiple granularities of the monitoring data, including metric values, events, logs, traces, and metadata. In some embodiments, analysis module 214 may allow a user to In some embodiments, analysis module 214 may incorporate user feedback data.

A recommendation generation module 216 may be configured to generate actionable recommendations for resolving identified AI system performance issues. For example, recommendation generation module 216 may suggest tuning portions of AI system 204, including, but not limited to, a prompt engine, a RAG, an LLM, or a trust layer.

FIG. 3 shows an example architecture 300 for implementing monitoring and observability of an AI system, in accordance with some embodiments. Architecture 300 may include a setup module 302, and AI system 304, a database 306, a metadata store 307, a data collection system 308, a monitoring stream processor 310, and an evaluation system 312.

Before monitoring of AI system 304 begins, a user may configure monitoring parameters in setup module 302. In setup module 302, a user may choose which metrics to monitor and their sampling frequency. This gives the user flexibility in the type and amount of monitoring data that is collected. The user may also define minimum and maximum threshold values for the metrics. The metrics may include, as non-limiting examples, a factuality score, a coherence score, a relevance score, or a task specific metric. The user may also specify a custom metric for monitoring the AI system, as will be understood by a person of ordinary skill in the art.

Metadata on the configuration of the monitoring parameters may be stored in metadata store 307. The metadata may include a list of metrics, metric sampling configurations, minimum and maximum threshold values for the metrics, and the like.

After setup, monitoring data may be collected during runtime of AI system 304 The monitoring data may include metrics, events, logs, traces, inference data, and usage data for components (e.g., LLM, prompt engine, retrievers, and trust layer) of AI system 304. In some embodiments, monitoring data may further include user feedback.

The monitoring data may be collected by data collection system 308. In some embodiments, data collection system 308 may comprise a real-time data streaming pipeline. The data streaming pipeline may be configured to store streams of data in the order in which they are generated.

The monitoring data collected by data collection system 308 is processed at monitoring stream processor 310. Monitoring stream processor 310 may receive the configuration metadata from metadata store 307. Then, the monitoring stream processor may sample the monitoring data at the sampling frequency specified in the configuration metadata. The sampled monitoring data may be stored as data model objects or data lake objects in database 306.

Monitoring stream processor 310 may send sampled monitoring data to evaluation system 312. Evaluation system 312 may evaluate the monitoring data to determine if the metrics if are in the predefined range.

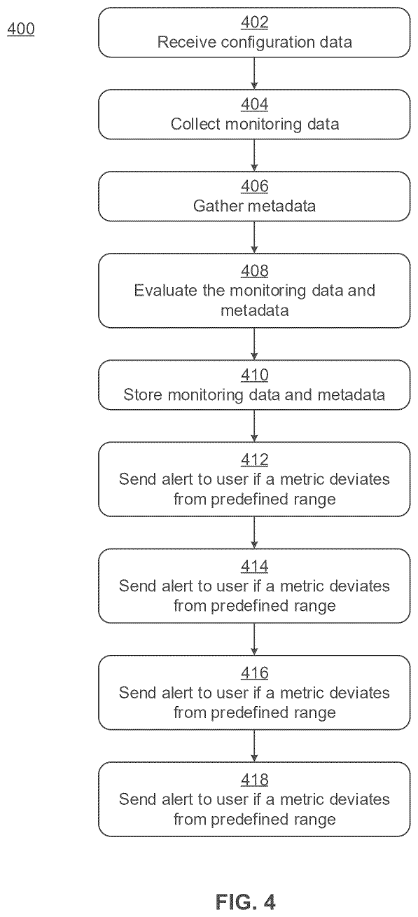

FIG. 4 shows a flow diagram of a method 400 for monitoring and observability of an artificial intelligence system, in accordance with some embodiments. It may be appreciated that not all steps of method 400 may be needed to perform the disclosure provided herein. Furthermore, some of the steps may be performed simultaneously, or in a different order than the one shown in FIG. 4, as will be understood by a person of ordinary skill in the art.

Method 400 may be implemented by one or more computer systems in an integrated platform, as described in reference to FIG. 2. This allows a user to setup, monitor, use, debug, and tune the artificial intelligence system in a single workspace.

At 402, method 400 may include receiving monitoring configuration data form a user. The monitoring configuration data may specify which metrics to track during runtime of an artificial intelligence system and the sampling frequency for metric collection. The monitoring configuration data may further specify threshold values for each metric. The one or more computer systems may store the configuration data in a database.

At 404, method 400 may include collecting monitoring data during runtime of an artificial intelligence system. The monitoring data may include metrics, events, logs, and/or traces. In some embodiments, the monitoring data further includes user feedback. For example, a user may rate the quality of a response generated by the artificial intelligence system.

At 406, the one or more computer systems may gather metadata. The metadata may include data on setup and runtime of the artificial intelligence system. Setup metadata may include a list of metrics to be tracked, metric sampling configurations, minimum and maximum threshold values for the metrics, and the like. Runtime metadata may include the full context of the execution of the AI system, including API calls, context, prompts, parallelism, etc.

At 408, method 400 may include evaluating the monitoring data and metadata. During the evaluating, the metric values may be calculated and compared to the threshold values.

At 410, method 400 may include storing monitoring data and metadata in a data cloud. Data can be stored as data lake objects (DLO) and data model objects (DMO). A data model object may include a grouping of data created from data streams, insights, and other sources. The monitoring data and metadata may be accessible to multiple modules of a monitoring and observability system, such as alert generation module 212 and analysis module 214.

At 412, method 400 may include sending an alert to a user if a tracked metric deviates from a predefined range. The predefined range of a metric may be determined at system setup. The alert may include a summary of the metric that outlines the metrics current value and when the metric started to deviate from the desired range.

At 414, method 400 may include displaying monitoring data, i.e., metric trends, logs, traces and/or events to the user. The monitoring data may be displayed on a dashboard embedded into the integrated platform, as described in reference to FIG. 2.

At 416, method 400 may include performing a root cause analysis. During the root cause analysis, one or more computer systems may evaluate the monitoring data and metadata to determine a source of performance issues in the AI system. During root cause analysis, metadata may be searched to identify monitoring data (metrics, events, logs, traces, etc.) relevant to the performance issue. Root cause analysis may also utilize user feedback.

In one non-limiting example, where a user is alerted that a toxicity metric is trending high, root cause analysis may involve the user asking an AI model to flag the customer case types that are resulting in the most toxic summaries. The AI model may analyze the events, logs, traces, and/or metadata to determine that when feedback cases are summarized, they are being evaluated as toxic.

In some embodiments, the root cause analysis may be performed manually by a user. For example, the user may systematically review the event, logs, and traces to determine the root of a performance issue.

At 418, method 400 may include issuing a recommendation to a user based on results of the root cause analysis. A recommendation may be issued based on the type of issue identified. For example, recommendations may include tuning a prompt, tuning a retrieval augmented generation (RAG) functionality, and fine-tuning a LLM.

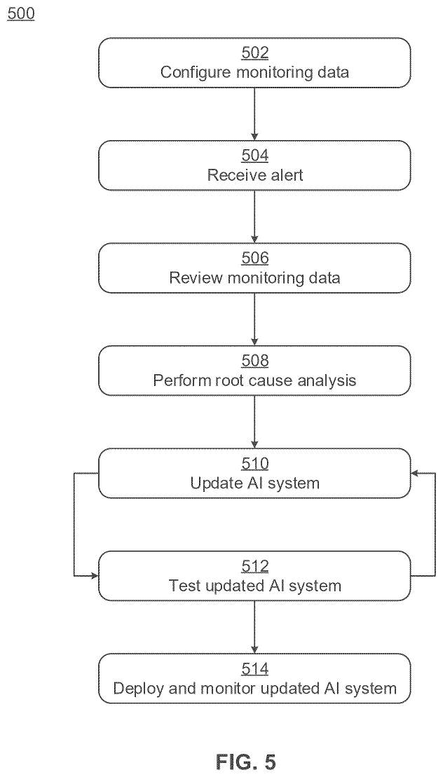

FIG. 5 shows a flow chart of a method 500 for monitoring and improving an AI system, in accordance with some embodiments. It may be appreciated that not all steps of method 500 may be needed to perform the disclosure provided herein. Furthermore, some of the steps may be performed simultaneously, or in a different order than the one shown in FIG. 5, as will be understood by a person of ordinary skill in the art. A user may perform method 500 in and integrated platform, as described in reference to FIG. 2.

At 502, a user may configure monitoring for an artificial intelligence (AI) system. Configuration may include selecting which metrics to monitor and their sampling frequency. After configuration, one or more computer systems may perform monitoring tasks on the AI system, as described above in method 400.

At 504, the user may receive an alert. The alert may notify the user that a metric has deviated from a predefined threshold. The user may receive the alert via user interface 202, via email, or the like.

At 506, the user may review monitoring data for one or more tracked metrics. As described above, monitoring data may include metric values, logs, traces, events, errors and inferences. The user may review the monitoring data in dashboard displayed by user interface 202.

At 508, the user may perform a root cause analysis. The root cause analysis may analyze metrics, logs, errors, events, traces, user feedback and/or metadata to determine a root cause of a performance issue in the AI system. The user can perform a root cause analysis using an application within system 200 of FIG. 2, such as analysis module 214. In additional embodiments, the user can perform the root cause analysis manually using by reviewing the monitoring data in a dashboard displayed by user interface 202.

At 510, the user may update the AI system to address the issue identified at 508. For example, updating may include tuning the prompt, RAG, or LLM. Other features of the AI system may be tuned or optimized as understood by a person of ordinary skill in the art.

At 512, the user may test the updated version of the AI system. Testing may include evaluating metrics of the AI system under different inputs and/or operating conditions. This may allow the user to determine if the updating performed at 510 fixed a performance issue of the AI system. If the update does fix the performance issues (e.g., metrics still outside of predefined range, the user may return to step 510 update the AI system.

At 514, the user may deploy and monitor the updated version of the artificial intelligence system.

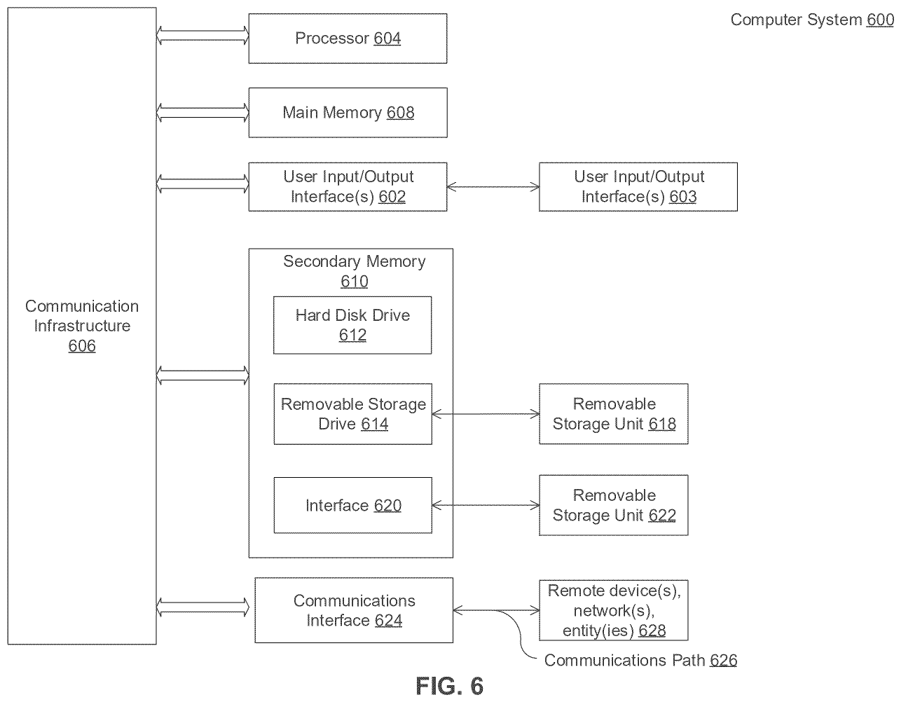

FIG. 6 illustrates an example computer system 600 useful for implementing various embodiments.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method, comprising:
collecting, by one or more computing devices, monitoring data during runtime of an artificial intelligence (AI) system;
gathering, by the one or more computing devices, metadata detailing monitoring setup and AI system execution; and
performing, by the one or more computing devices, a root cause analysis to determine a reason for performance issues of the artificial intelligence system using the monitoring data and the metadata, wherein the metadata provides context to the monitoring data during the root cause analysis.

2. The method of claim 1, wherein the monitoring data includes metrics, logs, events and traces.

3. The method of claim 1, further comprising gathering user feedback data, wherein the user feedback data is incorporated into the root cause analysis.

4. The method of claim 1, further comprising issuing to a user, by the one or more computing devices, a recommendation for improving the AI system based on results of the root cause analysis.

5. The method of claim 1, further comprising receiving, by the one or more computing devices, monitoring configuration data comprising metrics to be tracked and a sampling frequency for the metrics to be tracked.

6. The method of claim 1, further comprising sending, by the one or more computing devices, an alert to a user if a metric detailing performance of the AI system deviates from a predefined range specified by a user.

7. The method of claim 1, wherein the AI system is a large language model and the monitoring data is collected for a retrieval augmented generation functionality and a prompt functionality.

8. A system comprising:
a memory; and
a processor coupled to the memory and configured to:
collect monitoring data during runtime of an artificial intelligence system;
gather metadata detailing monitoring system setup and AI system execution; and
perform a root cause analysis to determine a reason for performance issues of the artificial intelligence system using the monitoring data and metadata, wherein the metadata provides context to the monitoring data during the root cause analysis.

9. The system of claim 8, wherein the processor is further configured to issue a recommendation for improving the AI system to a user based on results of the root cause analysis.

10. The system of claim 8, wherein the processor is further configured to sample monitoring data at a rate specified by a user during system setup.

11. The system of claim 8, wherein the processor is further configured to send an alert to a user if a metric detailing performance of the AI system deviates from a predefined range specified by the user.

12. The system of claim 8, wherein the monitoring data comprises metrics, events, logs, and traces.

13. The system of claim 8, wherein the processor is further configured to gather user feedback data, wherein the user feedback data is incorporated into the root cause analysis.

14. The system of claim 8, wherein the artificial intelligence system comprises a large language model (LLM) and the monitoring data is collected for a retrieval augmented functionality (RAG) and prompt functionality of the LLM.

15. A non-transitory machine-readable storage medium having instructions stored thereon that, when executed by a set of one or more processors, cause said set of one or more processors to perform operations comprising:
collecting monitoring data during runtime of an AI system;
gathering metadata detailing monitoring system setup and AI system execution; and
performing a root cause analysis to determine a reason for performance issues of the artificial intelligence model using the monitoring data and metadata, wherein the metadata provides context to the monitoring data during the root cause analysis.

16. The non-transitory machine-readable storage medium of claim 15, the operations further comprising alerting a user when a metric detailing performance of the AI system deviates from a predefined range specified by the user.

17. The non-transitory machine-readable storage medium of claim 15, the operations further comprising issuing a recommendation for improving performance of the AI system to a user based on results of the root cause analysis.

18. The non-transitory machine-readable storage medium of claim 15, the operations further comprising sampling the monitoring data at a rate defined by a user.

19. The non-transitory machine-readable storage medium of claim 15, the monitoring data comprising metrics, events, logs and traces.

20. The non-transitory machine-readable storage medium of claim 15, the operations further comprising gathering user feedback data, wherein the user feedback data is integrated into the root cause analysis.
